(19) United States
(12) Patent Application Publication
(10) Pub. No.: US 2008/0202362 A1
(43) Pub. Date: Aug. 28, 2008

(54) Substrate modification techniques for decorative purposes

(76) Inventor: David M. Stravitz, New York, NY (US)

Correspondence Address: BRIAN ROFFE, ESQ, 11 SUNRISE PLAZA, SUITE 303, VALLEY STREAM, NY, 11580-6111, US

(21) Appl. No.: 12/001,741

(22) Filed: Dec. 12, 2007

Related U.S. Application Data
(60) Provisional application No. 60/874,339, filed on Dec. 12, 2006.

(51) Int. Cl. B31F 1/07

(52) U.S. Cl. 101/6; 101/3.1; 101/18; 101/19; 101/24

(57) ABSTRACT

Instruments for modifying flat substrates to emboss, imprint or cut one or more patterns thereon includes an operative unit for modifying the substrate and structure which positions the substrate relative to the operative unit to enable the unit to interact with the substrate and modify it. Several different combinations of operative units and positioning structure are envisioned with each providing a different form of the substrate. The different combinations may be used together to create a piece of art from individually modified substrates.

### CROSS-REFERENCE TO RELATED APPLICATION

This application claims priority of U.S. provisional patent application Ser. No. 60/874,339 filed Dec. 12, 2006, which is incorporated by reference herein.

### FIELD OF THE INVENTION

The present invention relates generally to modification techniques and apparatus and methods for modifying paper and other flat substrates for decorative purposes. The present invention also relates more specifically to various tools and instruments for modifying substrates in order to imprint a pattern thereon, cut a pattern therein, emboss a pattern thereon, and otherwise transferring a pattern to the substrate to cause a change in the appearance of the substrate.

### BACKGROUND OF THE INVENTION

The scrap book, quilting, personal gift greeting cards, and overall graphic arts market has grown dramatically in the past few years. Today, the market has exceeded $20 billion in annual revenue, with home scrapbook and quilting reaching $5 billion in combined revenue and trending upward as one of the fastest growing sectors of the crafts market. Each state and community now often have numerous scrapbook and/or quilting clubs that meet regularly. Further, there are numerous regional shows, as well as national shows that regularly exhibit manufacturers' latest tools and instruments of the trade. Once considered a female craft, males are now being targeted as potential customers.

One of the instruments used in scrapbooking is designed to provide quick, precise and repeatable die cutting, imprinting and embossing of a given or predetermined pattern onto a flat substrate such as a paper substrate. There are numerous crafting die cutters, imprinters and embossers on the market manufactured by such firms as Fiskars (and referred to as corner dies, edge dies, 3¼″ deep long reach dies, 3 in 1 punch, anywhere punch). Other well know dies, with competitive featured dies are Mavy Uchida, Sizzex, Provo craft, EK success, Super Giant. All of these punches have common features, for example, most are hand-held punches that punch relatively to the edge of the paper, with the exception of a few long reach punches which punch as deep as 3¼″ from the edge into the paper. Further, since all are hand-held, none enable transferring a wafer-like tab permanently or sequentially removable from the substrate. Furthermore, none of these prior art die cutters and embossers are precise, and one must visually determine the subsequent location to punch in the event a continuous pattern is sought to be created. These prior art die cutters and embossers also have certain limitations. For example, the Fiskars Border punch does not provide deep adjustable interior wafer transferring and die cutting or precise indexing, cannot produce an angular cut and does not have the capability of transferring a permanent or removable tab. In fact, there are no such devices currently on the market that have this ability.

Another technique for modifying flat substrates such as paper is paper quilling, also known as paper filigree. Paper quilling is a 500 year old craft. In this art form, artists manually roll narrow strips of paper which they then squeeze to form, for example, scrolled, fluted and fringed patterns. These forms are glued on one of their edges to enable the formation of an infinite array of designs and patterns

Tools required for paper filigree are quite basic. A flat substrate such as paper is required, along with an instrument to wind the strips around and glue. Paper comes in various weights. A particular paper weight is selected generally depending on what the finished design is expected or desired to look like. The paper is first cut into strips from about ⅛ inch to about 1 inch wide and ⅛ inch being fairly standard. Often a toothpick is used to wind the paper into coils, but needles, pins, hat pins as well as specially designed quilting tools are also commonly used. A common aspect of these instruments is that they are all manual and therefore require significant time to wind the paper strips into rolls. The glue, or adhesive, used to actually form the designs from the rolled strips of paper can be ordinary clear-drying white glue, although for paper that has been sprayed with metallic paint, a heavier, clear-drying glue may be preferred.

Once the materials are ready, the artist proceeds to roll the strips and form various basic shapes. Basic shapes include a “V” shape which is obtained by folding a strip in half and rolling the ends on the outside of the paper, away from the inner crease. A feeler is obtained by rolling only a small part of the paper strip, leaving the rest of the strip straight. Feelers can be made with the strip folded in half, or just with one coil from an unfolded strip. A peacock eye can be made from either a loose or tight coil. After the coil is made, the artist pinches one side. A petal can be formed by bending the tip of the peacock eye slightly to one side. A three-dimensional contoured peg is obtained by, after rolling a tight coil, pushing the peg up from underneath the center to contour its shape and provide the three-dimensional look to the paper strip. A basic peg is obtained by rolling a strip of paper tightly and gluing the end while the coil is still tight. Pegs can be used in the design or glued to the underside of another shape to raise it thereby creating a three-dimensional look to the design. A quote is obtained by folding the strip in half and rolling the ends in the same direction so that one coil will b rolled toward the center crease ad one coil will be rolled away from it. An open heart is formed by folding the paper strip in half and rolling the ends toward the center of the crease. A tendril is obtained by rolling the paper strip in a spiral shape around the toothpick, or other tool, as tight as desired. It is alternatively referred to as a spiral, rope or twist. An “S” shape is obtained by rolling the paper strip from both ends but on opposite sides of the strip. The foregoing are some examples of basic shapes used in paper filigree and there are other known forms.

Regardless of how the paper strip is manipulated, it still must be manipulated manually, i.e., to roll the strip about the toothpick or other tool. This is significantly time-consuming, laborious and tedious. It would therefore be desirable to provide an instrument for paper filigree which eliminates the need to manually roll the paper strips.

### OBJECTS AND SUMMARY OF THE INVENTION

It is an object of the present invention to provide new apparatus and methods for modifying flat substrates and transferring patterns to such substrates or forming patterns in such substrates.

In order to achieve this object and possibly others, a first embodiment of an instrument or tool for modifying flat substrates in accordance with the invention generally includes an operative unit for modifying the substrate and structure which positions the substrate relative to the operative unit to enable the unit to interact with the substrate and modify it. Several different combinations of operative units and positioning structure are envisioned with each providing a different form of the substrate. The different combinations may be used together to create a piece of art from individually modified substrates.

In one particular embodiment of an instrument in accordance with the invention used for embossing, imprinting or cutting patterns in a substrate, the operative unit includes at least two rollers arranged in a housing and defining at least one nip therebetween through which the substrate passes. At least a first roller includes one or more modification components, e.g., projections or cutting implements, which depress or cut the substrate when the substrate is passed through the nip to thereby emboss, imprint and/or cut the substrate. Different combinations of the modification components may be used, e.g., a cutting implement on one part of the roller and a series of projections on another part of the same roller. Each roller may be replaceable to enable multiple rollers with different patterns of modification components to be arranged in the housing and to create different embossed or imprinted patterns or cuts in the substrate. A mechanism is provided to enable manual or automatic rotation of the rollers to cause the substrate to be drawn into the nip between the rollers.

In a variation of this instrument, a pressure plate is arranged to enable pressure to be manually exerted against one of the rollers in a direction toward another roller forming a nip therewith. This facilitates the ability to manually determine the force at the nip and thus the force the substrate being modified is subjected to, which causes variations in the embossed, imprinted or cut pattern in the substrate.

In another variation, the housing includes a container portion defining a receptacle for receiving the modified substrates, i.e., the substrates after having passed through any nips defined by the plurality of rollers, and an operative portion housing the rollers. The container portion includes a slot through which the modified substrates pass into the receptacle and the operative portion includes a slot into which the unmodified substrate is passed into the nip defined by the rollers.

In another substrate modification instrument in accordance with the invention which is used for paper quilting or filigree, the operative unit includes a housing, a rotatable shaft extending from the housing, an electrical unit arranged at least partly in the housing for providing power to rotate the shaft and a mechanism for actuating the electrical unit to initiate rotation of the shaft. The shaft includes a threading slot at a tip spaced from the housing. Upon insertion of a leading edge of a strip of the substrate in or into the slot and actuation of the electrical unit, the shaft rotates and twists the strip into a curved form.

For this instrument, a work board may be provided which defines one or more geometric forms, either of the same shape and different sizes or different shapes and sizes, with each form having an inlet into an interior thereof. In use, the tip of the shaft would be inserted into an interior of a geometric form with the substrate extending through the inlet and then the shaft is rotated to thereby cause the substrate to achieve a shape approximately corresponding to the geometric form. Glue or another adhesive is then applied to an edge of the rolled substrate and the rolled substrate is adhered to another substrate to create a piece of art.

In another embodiment of an instrument in accordance with the invention, for use in embossing or imprinting patterns into a substrate, the operative unit includes a base, one or more transfer tabs arranged in connection with the base and an actuator for pressing the substrate against the transfer tab(s). The actuator may be pivotally coupled to the base. The base may include a receptacle for removably receiving the transfer tab(s) so that multiple and different transfer tabs can be used with the instrument. Each transfer tab includes a plurality of raised projections preferably tapering to a point and the actuator includes a plurality of holes which align with the projections. Thus, the projections can cleanly pierce the substrate.

In this instrument, the positioning means may include a guide mechanism arranged in connection with the base for positioning the substrate relative to the transfer tab(s). The guide mechanism can be releasably coupled to the base for accurate positioning. The guide mechanism can also include a pair of edges defining an acute angle therebetween, i.e., to enable a corner of the substrate to be accurately retained in position relative to the transfer tab(s).

Another instrument for modifying a flat substrate in accordance with the invention includes a base member, an actuator member movably coupled to the base member, a first pad arranged on the base member and a second pad arranged on the actuator member in a position in which it can be brought into contact with the first pad when the actuator member is moved toward and pressed against the base member. With this instrument, when a flat substrate and a form or die are placed between the first and second pads, with the form or die above or below the substrate, movement and pressing of the actuator member toward and against the base member causes the form or die and the substrate to be pressed between the first and second pads thereby creating an imprint of the form or die in the substrate.

### BRIEF DESCRIPTION OF THE DRAWINGS

The invention, together with further objects and advantages, may be best understood by reference to the following description taken in conjunction with the accompanying photos, wherein like reference materials identify like elements, and wherein:

FIG. 1 is a perspective view of a first embodiment of an apparatus for embossing/die cutting in accordance with the invention.

FIG. 2 is a cross-sectional taken along the line 2-2 of FIG. 1.

FIG. 3 is a cross-sectional taken along the line 3-3 of FIG. 1.

FIG. 4 is a perspective view of a second embodiment of an apparatus for embossing/die cutting in accordance with the invention.

FIG. 5 is a cross-sectional taken along the line 5-5 of FIG. 4.

FIG. 6 is a perspective view of a third embodiment of an apparatus for embossing/die cutting in accordance with the invention.

FIG. 7 is a cross-sectional taken along the line 7-7 of FIG. 6.

FIG. 8 shows an instrument for automated paper quilling or filigree.

FIG. 9 shows a work surface for use with the instrument shown in FIG. 1

FIG. 10 shows the initial and final stages of a paper strip used with the instrument shown in FIG. 1.

FIG. 11 is a perspective view of another instrument for modifying paper and flat substrates in accordance with the invention by embossing a portion thereof.

FIG. 12 is an enlarged view of a portion of the instrument shown in FIG. 11.

FIG. 13 is a view of a transfer tab used with the instrument shown in FIG. 11.

FIG. 14 is a cross-sectional side view of the instrument shown in FIG. 11.

FIG. 15 is a top view of a guide used with the instrument shown in FIG. 11.

FIG. 16 is a side view of another instrument for modifying substrates in accordance with the invention.

FIG. 17 is a top view of another instrument for modifying substrates in accordance with the invention.

FIG. 18 is a cross-sectional taken along the line 18-18 of FIG. 17.

FIG. 19 is a cross-sectional taken along the line 19-19 of FIG. 17.

FIG. 20 is an enlarged view of the portion designated 20 in FIG. 19.

FIG. 21 is a view of the bottom of the punch and indexing lever of the instrument shown in FIG. 17.

FIG. 22 is a view of an alternative actuating mechanism for the instrument shown in FIG. 17.

FIG. 23 is a top view of an adjustable rail for use with the instrument shown in FIG. 17.

### DETAILED DESCRIPTION OF THE INVENTION

Referring to the accompanying drawings, several different instruments for modifying substrates are disclosed. The instruments can be used in combination with one another to modify the same substrate or may be used to modify different substrates with the different modified substrates capable of being used in a common piece of art.

Referring first to FIGS. 1-3, this embodiment of an instrument of modifying paper or other flat substrates, such as metal foil, synthetic substrates and the like, is designated generally as 10 and includes a housing 12 and a mechanism for feeding the paper 14 through a pair of rollers 16, 18 in order to, for example, transfer high relief onto the paper 14. In this manner, a hobbyist, scrapbooker and graphic artist can easily produce high depth relief patterns on paper, foil, etc. Instrument 10 is also designed to enable easy changing of one of the rollers 16 to facilitate obtaining different patterns for subsequent repeating patterns, although other instruments could enable easy changing of any rollers therein.

Generally, using instrument 10, a repeat pattern that is embossed, imprinted and/or die cut can be formed by inserting flat plain paper 14, or a synthetic substrate, between two or more rollers, two rollers 16, 18 being shown in the embodiment of FIGS. 1-3. A hand crank 20, or motorized gear mechanism, will rotate the rollers 16, 18 in opposite rotational directions so that they draw the paper substrate 14 through a nip formed therebetween from one end to the other. As the paper 14 is drawn through the nip, the raised detailed pattern on one of the rollers 16 causes the pattern to be transferred into the paper 14, while not tearing the paper.

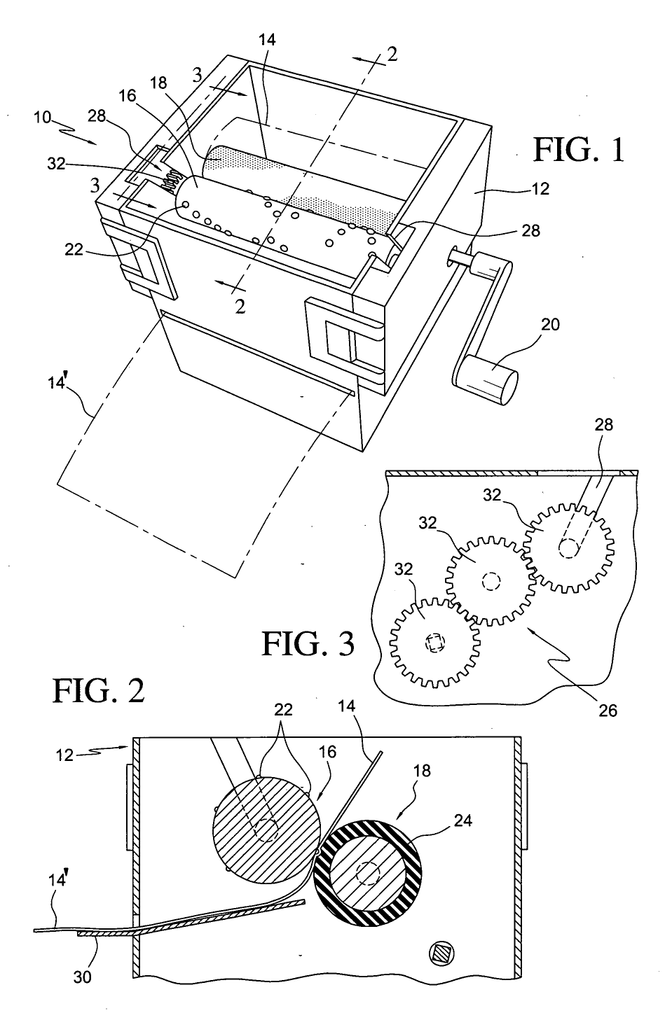

The non-detailed roller 18, which may be a medium durometer roller, controls this level of depth, i.e., the level of penetration of the projections 22 forming the pattern on roller 16 into the paper 14 (see FIG. 2). A softer rubber covering 24 on roller 18 will provide deeper indentations and harder rubber in covering 24 will provide less. The rubber covering 24 is designed so that during embossing, it will be indented or depressed as a function of the size and shape of the projections 22 on the roller 1, but this indentation or depression will only be temporary and the covering 24 will revert to its initial or original form after a period of time. Thus, the covering 24 is self-healing.

Both rollers 16, 18 are rotated inward to each other to move the paper 14 continuously from the beginning to the end. Thus, the instrument 10 can automatically pinch plain un-detailed or unmodified paper 14 and draw it one end and cause it to exit embossed, imprinted and/or cut through the other end.

As shown in FIG. 3, crank 20 is connected to a gear mechanism 26 which converts the manual rotation of crank 20 into inward rotation of both rollers 16, 18. Gear mechanism 20 may include a plurality of gears 32 situated on both sides of the rollers 16, 18. Other gear mechanisms may be used, as well as an automatic or motorized system to initiate the rotation of the rollers 16, 18. Such a motorized or automated system may be battery operated, with the batteries housing in a compartment on housing 12 and connected to a motorized gear system, AC-motor driven or DC-motor driven.

Roller 16 is replaceable to enable different patterns to be formed, with each roller 16 having a different pattern of projections which may be different sizes, shapes, etc. Alternatively or additionally, it is possible to place blades or other cutting instruments on the roller 16 to enable a die cut pattern to be formed, i.e., enable instrument 10 to be a die-cutter. Thus, in one embodiment, both projections and blades can be provided on roller 16. Using die cutting heads along one or both rollers 16, 18, instrument 10 enables a die cut pattern to be repeatedly formed in paper substrate 14. Different die cutters can be combined on one or more of the rollers 16, 18 to produce various repeat patterns along the paper substrate 14. Thus, any type or form of substrate modification component can be provided on the rollers 16, 18, e.g., projections, blades and the like. Moreover, each roller 16, 18 could be inserted in either orientation in the housing 12 which would, for example, create different patterns if the pattern was not symmetric to the center of the roller. Thus, the axial orientation of the rollers 16, 18 is another parameter which affects the pattern being produced thereby.

To enable variable and interchangeable use of roller 16, a pair of angled slots 28 is provided to enable insertion and removal of roller 16 into the housing 12. The housing 12 and slots 28 are formed so that when roller 16 is engaged with the gear mechanism 26, upon rotation of the crank 20, roller 16 is maintained in the housing 12 and urged in a direction opposite to the opening of the slot 28. Removal of roller 16 would therefore entail rotating roller 16 in the opposite direction. Other mechanisms to maintaining roller 16 in housing 12 yet allowing for easy removal are also envisioned to be within the scope and spirit of the invention.

Roller 18 may also be provided with projections and/or cutting blades and may also be removable in a similar manner as roller 16 is removable. Whatever rollers 16, 18 are being used and whatever composition, e.g., made of rubber or synthetic material, the rollers 16, 18 are arranged in housing 12 to have a reasonable amount of give and are engaged in parallel orientation so that they substantially indent their surface into each other when moved toward each other (rotated inward against each other). Prior to the paper or foil substrate 14 being inserted, the parallel rollers 16, 18 thereby engage each other under pressure.

Housing 12 also includes a shelf 30 to guide the embossed or die cut paper 14′ out of the housing 12.

In use, the artist inserts a plain piece of paper, foil or other substrate 14 (or moistened watercolor paper for deeper detail) between the rollers 16, 18, with one or more of these rollers, e.g., roller 16, having convex or concave detail. The paper substrate 14 is inserted between the two rollers and then crank 20 is turned which draws the paper substrate 14 between the nip formed by rollers 16, 18 so that the relief detail from roller 16 transfers the detail to the paper substrate 14. The non-detailed roller 18 provides a give which receives the detail (see FIG. 2 wherein the covering 24 on roller 18 is shown indented by an amount related to the size of projection 22 on roller 16). Depending on the diameter of the rollers 16, 18, the pattern is repeated equally continuously from the beginning of the paper substrate 14 to the end. The net result is a repeated pattern of concave detail on the paper substrate 14 on one side, and convex detail on the reverse side.

It is possible to synchronize the rollers 16, 18, which would be particularly useful when both rollers 16, 18 have projections. This would create the possibility of producing both concave and convex detail on both sides of the paper substrate 14. The projections on the rollers 16, 18 could thus intermesh with each other. It is important to add that each roller 16, 18 can have both convex and concave detail, thus producing concave and convex detail on each side of the paper substrate 14.

Roller 16 has the ability to be variably detailed by adding or deleting detail elements, e.g., projections 22, that affix easily to the roller 16 (which also is applicable to roller 18 when detailed). Roller 16 is easily removable to facilitate this, e.g., in the manner described above. As such, it is possible to stop in the middle of the embossing or die-cutting process, remove roller 16 and replace it with another roller containing other detail or modifying the existing roller 16 with new detail. Once this is accomplished, the modified or new roller 16 is re-inserted into housing 12 and the embossing or die-cutting process continues. The net results will be two or more different repeated patterns along the paper substrate 14.

Instrument 10 as shown is designed to accept about 3″ strips but can be made wider to accept conventionally commercially dimensioned papers and foils, such as 8½″ or 11″ wide paper.

Instrument 10 enables an artist to achieve several objectives including facilitating repetitions of embossing and die cutting planar substrates (paper, foil, synthetic), providing a useful instrument that offers more flexibility in the breadth of possible designs that can be formed, providing an instrument that enables repetition of a die cut pattern into the substrate, e.g., the ability to repeat die cut a pattern, for example, a heart, so that the net result will be hearts die cut repeatedly along the substrate. In one exemplifying use, the artist can bend a sheet of paper, two, three or more times, and then pass the bent sheet through the nip defined by the rollers 16, 18. When the sheet is unfolded, the pattern will therefore appear two, three or more times.

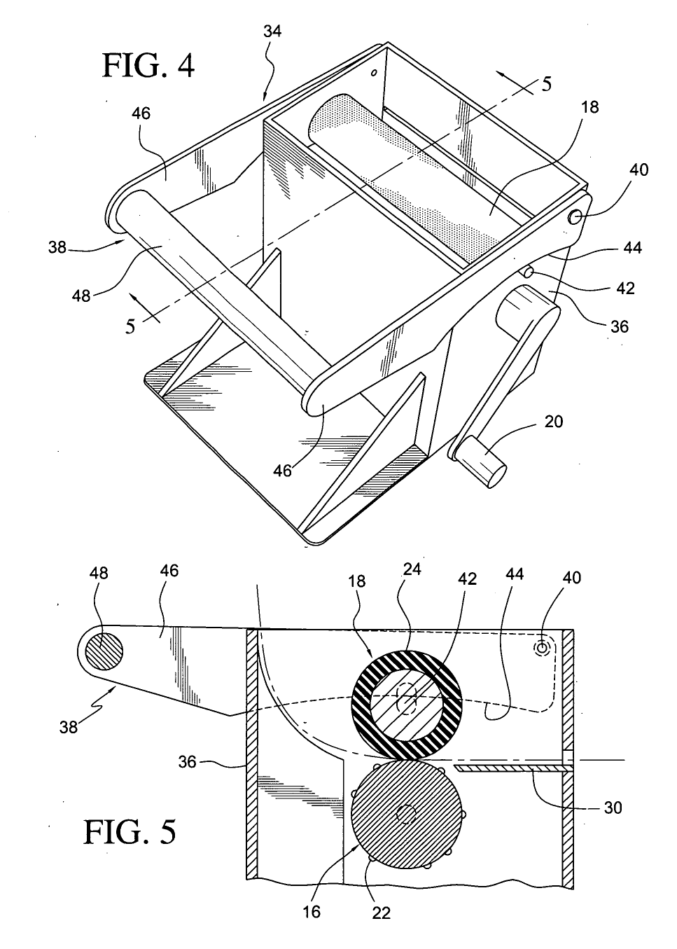

Referring now to FIGS. 4 and 5, a second embodiment of an embossing and die-cutting instrument in accordance with the invention is designated generally as 34 and is similar to the instrument 10 in FIGS. 1-3 so that the same reference numbers refer to the same or similar elements as in that embodiment. However, instrument 34 includes a different housing 36 and a front lever pressure plate 38 that presses the two rollers 16, 18 tightly to each other while cranking the paper substrate through a nip defined between the two rollers 16, 18.

More specifically, pressure plate 38 includes side panels 46 pivotally mounted to the housing 36 at pivot points defined by a pair of pins 40 attached to opposed sides of the housing 36. An arcuate surface 44 of each side panel 46 bears against an axial projection 42, or the ends of an axial core, of the roller 18. The axial projections 42 are movable in slots formed on the housing 36. As such, when the artist exerts pressure against a handle 48 extending between the side panels 46, the side panels 46 are urged downward contacting the axial projections 42 and pressing the roller 18 against roller 16. These slots may extend to the upper surface of the housing to enable easy removal of roller 18, once the pressure plate is pivoted upward out of the way.

Although pressure plate 38 serves to exert the necessary pressure on the paper 14 to enable the formation of an embossed pattern thereon, in some embodiments of the invention, e.g., the embodiment described above with respect to FIGS. 1-3, there is no need for a pressure plate because the angled slots 28 and gear engagement via gear mechanism 26 always causes pressure to be exerted by the rollers 16, 18 against each other immediately upon engaging the crank 20.

In this embodiment, the artist may need to hold the pressure plate 28 with one hand and turn the crank 20 with the other. Therefore, this embodiment would be especially beneficial to include a motorized crank system. Also in this embodiment, rollers 16, 18 can be interchangeable as desired via, e.g., appropriate construction of the housing 36.

Housing 36 of instrument 34 may be provided with one or more suction cups on its lower surface to aid in stabilizing the instrument 34 on a flat surface. In a similar manner, one or more such suction cups may be provided on the housings of the other instruments disclosed herein.

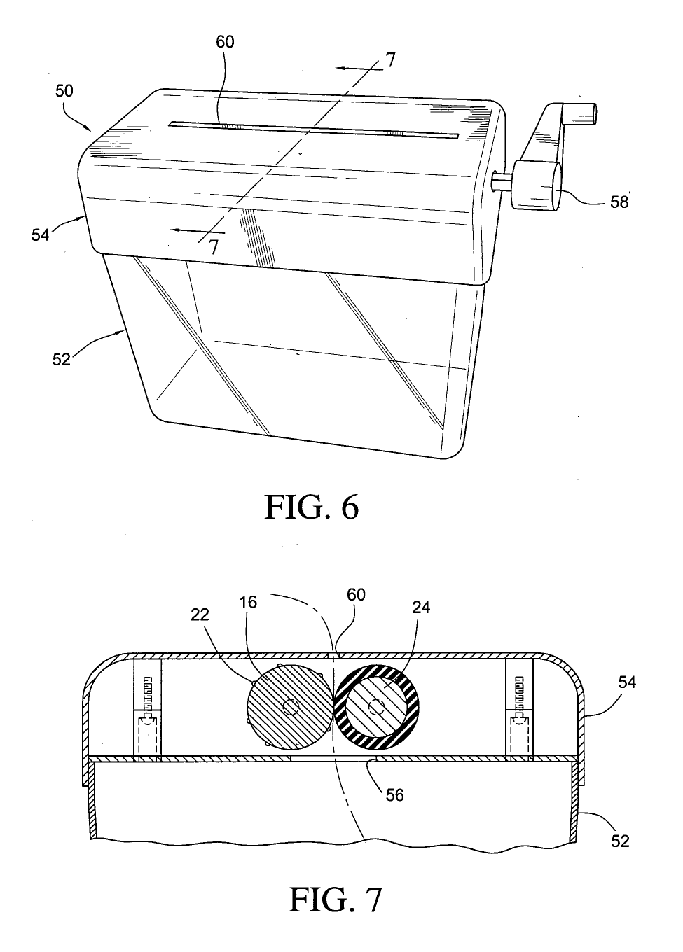

Referring now to FIGS. 6 and 7, a third embodiment of an embossing, imprinting and/or die-cutting instrument in accordance with the invention is designated generally as 50 and is similar to the instrument 10 in FIGS. 1-3 so that the same reference numbers refer to the same or similar elements as in that embodiment. However, instrument 50 includes a different housing having a container portion 52 and an operative portion 54 removably coupled to the container portion 52. Container portion 52 has any desired size and shape and defines an accessible receptacle for receiving modified substrates, and an opening 56 at an upper portion into which the embossed paper enters into the receptacle (see FIG. 7). Operative portion 54 includes rollers 16, 18, both of which are fixed as shown in the illustrated embodiment, although it is possible to mount one or both of them to be removable, and a slot 60 through the unmodified paper substrate is passed into engagement with the rollers 16, 18. One of the rollers 16, 18 is coupled to a hand crank 58 (but can also be motorized) either directly or through a gear mechanism (not shown in this embodiment). The roller which is coupled to the hand crank 58 is preferably the roller having the pattern or projections 22 or indentations thereon.

In use, as the artist turns the crank 58, the rollers 16, 18 rotate inward against each other, and draw the paper substrate down through the nip defined between rollers 16, 18, pressing one roller into the other and causing the paper substrate to receive the embossed or die cut detail, and then fall into the container portion 52 through opening 56. The container portion 52 is opened to retrieve the modified substrate,

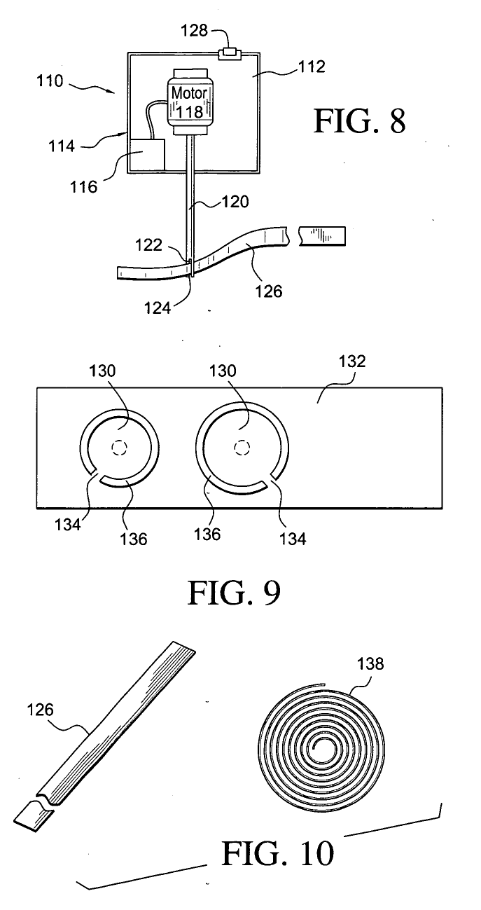

Referring now to FIGS. 8-10, this embodiment of the invention is an automatic paper quilting instrument 110 which eliminates the laboriously tedious task of manually rolling paper strips when practicing paper filigree. It therefore provides a considerably more expedient finish to the design process. Moreover, the automatic paper quilting instrument 110 results in a definite registration for different shapes and lengths, as opposed to the irregular shapes and lengths which typically arise from manual rolling of the paper strips.

Instrument 110 serves as an easy to handle tool which takes the tedious task of manual quilting operation to a much more automatic and rapid finish. Moreover, while manually quilting can often be irregular and out of line, instrument 110 is capable of providing a more precise registration for different shapes, diameters and lengths or rolled paper strips.

Automatic paper quilting instrument 110 includes a housing 112, a rotatable shaft 120 and an electrical unit 114 for providing power to rotate the shaft 120. The electrical unit 114 may comprise a battery 116 and a motor 118 and connections from the motor 118 to the shaft 120 or an electrical cord and connections and standard electrical components connecting the cord to the shaft 120. The housing 112 may be any shape and size, and could be one which is easy gripped by the artist. The shaft 120 includes a threading slot 122 at its tip 124 for easy and quick engagement with the leading edge of the paper strip 126. Threading slot 122 may be open to the bottom of the tip 124, in which case, the leading edge can be inserted downward into the slot 122, or formed as a closed slot open to the sides, in which case, the leading edge of the paper strip 126 is inserted sideways into the slot 122. A button 128 is provided to begin rotation of the shaft 120 and is therefore electrically coupled to the electrical unit 114 in the housing 112, e.g., the motor 118.

In use, the artist threads the leading edge of the paper strip 126 into the slot 122 in the tip 124 of the shaft 120. Once the leading edge of the paper strip 126 is engaged with the tip 124, the artist inserts the tip 124 and engaged paper strip 126 into a compartment 130 on a substantially planar upper surface of a work board 132 having the size, e.g., diameter, desired for the rolled paper strip (see FIG. 2). Work board 132 has two compartments 130 with different diameters and a notch 134 is formed in the peripheral wall 136 defining each compartment 130 to allow the paper strip to pass into the compartment 130. Compartments 130 have varying diameters and optionally a recess, indentation or depression is formed in the center of each compartment 130 to aid in placement of the tip 124 in the center of the compartment 130. Although a work board 132 is preferably available for use, it is possible to use automatic paper quilting instrument 110 without the work board 132. Indeed, one can use the automatic paper quilting instrument 110 in connection with hand coupling and in fact, unusual spring-like patterns can be created in this manner. Moreover, compartments 130 can be substantially circular as shown or have other shapes.

Once the tip 124 with the engaged paper strip 126 has been inserted into one of the compartments 130 on the work board 132, and specifically into the recess, indentation or depression in the center of the compartment 130, and passing through the notch 134 in the peripheral wall 136 of the compartment 130, rolling of the paper strip 126 about the tip 124 starts when the button 128 is pushed and the shaft 120 and tip 124 rotate. The height of the notch 134 is selected in consideration of the depth of the recess, indentation or depression in the compartment 130. The paper strip 126 is rolled around the tip 124 with the length of the paper strip 126 passing into the compartment 130 through the notch 134. Once the paper strip 126 has been completely rolled around the tip 124, a coiled paper roll 138 is formed (as shown in FIG. 10 which also shows the initial linear state of the paper strip 126) and the tip 124 is then removed from engagement with the thus-formed paper roll 138. The paper roll 138 unrolls slightly, i.e., is relaxed, when the tip 124 is removed from engagement therewith, i.e., it is relaxed. The diameter of the compartment 130 determines the diameter of the coiled paper roll 138, so that if a desired diameter paper roll is desired, a compartment having approximately that diameter would be used. Also, the height of the peripheral wall 136 should be slightly less than the height of the paper strip 126 being rolled to ease removal of the coiled paper roll 138 from the compartment 130.

Rotation of the shaft 120 and tip 124 can be controlled, e.g., via an adjustable button 128 or other motor control system, to provide for tighter or looser winding of the paper strip 126, so that the degree to which the paper roll 138 relaxes once the tip 124 is removed from engagement therewith is variable.

Once the paper roll 138 is relaxed, if so desired, it is removed from the compartment 130 on the work board 132 and may be re-shaped by the artist, and then prepared for insertion into the design, e.g., by gluing a lower edge of the rolled paper strips 138.

In summary, instrument 110 may be battery-operated, DC or AC operated, and serves to enable flat strips of paper to be wound in a much more rapid fashion in comparison with manual winding, substantially reducing tedious manual operation. Accordingly, problems with manual operation, e.g., the fact that it is time consuming and can cause extreme pain in wrists, knuckles, palms, etc., are mostly avoided. As such, ailments related to the hands, such as arthritis, carpel tunnel syndrome, cramps, and the like, are also substantially avoided.

In spite of the detailed description above, a general form of instrument 110 generally includes means for enabling quick engagement or a rotatable member to a leading edge of a strip of paper, selection of one of a predetermined number, size and shape of geometric forms into which the strip of paper is to be formed, and then easy actuation of a control mechanism for the rotatable member (once the edge of the strip of member is engaged with the rotatable member). Actuation of the control mechanism causes to rotatable member to rotate and quickly and precisely twirl the strip of paper into its designated form. Once finished, the artist can easily remove the twirled paper for subsequent reshaping and finally optional insertion into a larger artwork. The artist can also easily change different patterns for subsequent repeating patterns.

Instrument 110 thereby provides a new manner for performing paper quilting or filigree which enables an automatic rolling of paper strips, as well as enabling rapid quilting or filigree of strips which are used for various creative endeavors. The motor-driven instrument offers speed, precision and more flexibility to crafters, framers, graphic artists, scrap-bookers, quilters, etc. Moreover, when the compartments 130 of the work board 132 are used, the patterns of rolled paper strips having the same shape can be created since defined templates are used, thereby improving the formation of substantially identical rolled paper forms. Additional advantages provided by instrument 110 include providing relief or preventing discomfort from tedious winding of the paper strips, or fabric strips by hand when performed paper quilling or filigree and to provide speed and accuracy to enable completion of a project when working together in team efforts, such as craft clubs and craft meets. It is quite possible to complete a project in a single evening; one which might have taken many days to complete otherwise.

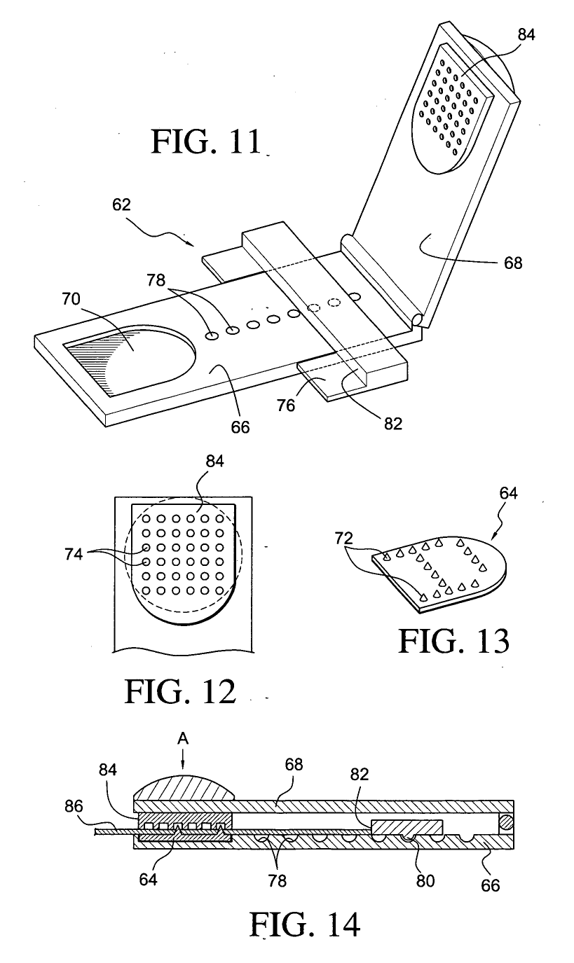

Referring now to FIGS. 11-15, another instrument for modifying paper substrates is designated generally as 62 and enables the formation of deep penetrating embossing of paper, as well as other flat substrates. Instrument 62 is designed to provide quick, precise and repeatable die cutting and embossing of a given pattern, depending on a die or transfer tab 64 placed into the instrument 62. Instrument 62 enables an artist or crafter to adjust the depth and angle of tab transfer or die cut, i.e., the distance from an edge of the paper sheet at which the transfer tab 64 will be operative to emboss and/or cut the substrate. It is also possible to incorporate an adjustable indexer that will provide equal advancement for deep die cutting or tab transferring. Instrument 62 provides a precision device that is capable of a variety of deep die cutting and also provides the capability of inserting the transfer tabs 64, which are thin wafer-like molded shapes, designs and letters into the substrate, e.g., paper, foil, synthetic sheet, etc. These wafer-like rigid components are designed to pierce the substrate with tapered points and the substrate when pierced by these shallow tapered points will naturally grab 360 degrees surrounding these points, and thus leave a clean pierced design in the paper. By providing a variety of transfer tabs 64, instrument 62 allows for a variety of new and exciting tools for the graphic arts, scrap book, and quilting artists. Furthermore, instrument 62 can function as a training tool for youngsters who are just beginning their cognitive stage. Furthermore, crafting using instrument 62 can become a family affair with everybody participating to create unique works for holiday gift giving, etc. From a commercial standpoint, instrument 62 in combination with the transfer tabs 64 offers a huge potential replacement market (the molded, ideally plastic, wafers can be sold in assorted packaged designs and letters).

Instrument 62 is shown in FIG. 11 and comprises a base 66 and an actuator 68 rotatably or hingably mounted to one end of the base 66. In one extreme position, the actuator 68 may be almost 180° rotated from the base 66 while in another, operative position, the actuator 68 is parallel to and on top of the base 66. Base 66 includes a recess 70 having a specific shape which is also the shape of the transfer tabs 64. This shape can vary as desired. Base 66 can also include a plurality of recesses, each of which is designed to receive a respective transfer tab, or a larger recess which is designed to receive multiple transfer tabs.

Each transfer tab 64 includes one or more raised prongs or projections 72 which are formed or arranged in a pattern, e.g., the letter “A” in FIG. 13. Each projection 72 is tapered to define a sharp point at its upper end to enable the projection to cleanly pierce the paper substrate when placed over the projection 72. Moreover, the tapering of the projections 72 enables the paper substrate to grab itself around the projections thus causing a tight bond to be formed.

The actuator 68 includes a plurality of holes 74 which align with the projections 72 on the transfer tab 64. To this end, the holes 74 may be formed in a matrix which includes one hole at each possible position of a projection 72 (see FIG. 12). In this manner, when different transfer tabs 64 are used, and which have different patterns of projections 72, each projection 72 will align with one of the holes 74 and pass therein when piercing through the substrate. For example, the matrix of holes 74 show on the actuator 68 is a matrix of 6 by 6 holes and letters, shapes and patterns for different transfer tabs 64 can be formed using this matrix. Thus, a heart shaped, square shaped, circular shaped, and diamond shaped, transfer tab can be provided. Also, more complex designs can be performed using the thirty-six projections corresponding to the matrix of holes 74 or a larger matrix can be provided to even further increase the variability of possible designs, i.e., to include digital numbering, lettering and artistic stylizing.

Instrument 62 also includes a guide mechanism for positioning the paper substrate into which the pattern formed by the projections 72 on the transfer tab 64 is to be formed. The guide mechanism includes an adjustable guide 76 which slides along the base 66 to different positions determined by correspondence between male and female members on the guide 76 and the base 66. In the illustrated embodiment, the base 66 includes a plurality of female members, i.e., depressions 78 equally spaced apart from one another, e.g., every 0.25 inches. The guide 76 includes a male member, i.e., projection 80 which is fit into one of the depressions 78 at each possible relative position of the guide 76 to the base 66. Thus, the guide 76 is moved along the base 66 until the distance between a positioning edge 82 of the guide 76 is at a desired distance from the transfer tab 64 and then the paper substrate is placed against the positioning edge 82. In this position, when the actuator 68 is lowered and pressed against the transfer tab 64, e.g., via a press 84 mounted to the actuator 68, the pattern of the transfer tab 64 will be formed at a desired location on the substrate.

Transfer tabs 64 may be made of various materials including, for example, molded plastic, e.g., rigid polystyrene.

FIG. 14 shows an operative position of the instrument 62 wherein a paper substrate 86 is placed against the positioning edge 82 of the guide 76 and the actuator 68 is being pressed against the transfer tab 64 in the direction of arrow A. It is possible to place two or more sheets of paper 86 between the transfer tab 64 and the press head of the actuator 68 so that when the sheets are different colors, the lowermost colored sheet will be pressed through holes in the uppermost sheet to thereby create a colored pattern in the uppermost sheet. Moreover, the same substrate 86 may be repeatedly pressed using instrument 62 with different transfer tabs 64 to thereby enable the formation of complete names.

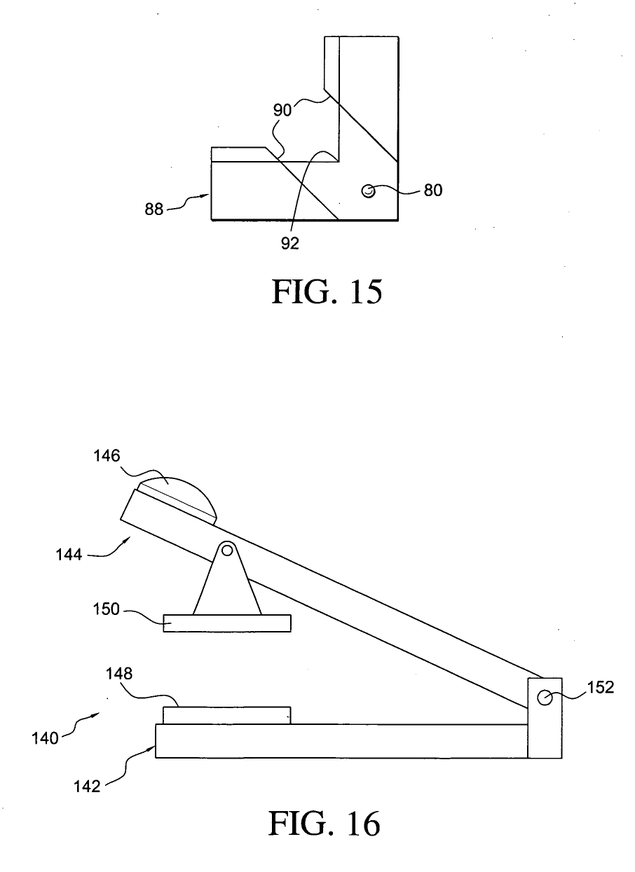

FIG. 15 shows a different adjustable guide 88 that can be used with instrument 62. Guide 88 includes a projection 80 like guide member 76 but is structured so that when engaged with base 66, i.e., with base 66 positioned between a pair of edges 90, it presents a pair of surfaces defining an acute angle therebetween, i.e., a corner 92, against which the substrate is positioned. Thus, instead of placing the flat edge of a substrate against a positioning edge of guide member 76, one would place a corner of the substrate against the corner 92 and thereby form the pattern of the transfer tab 64 at somewhat of an angle to the edges of the substrate. Guide 88 can be formed to present different angles for the positioning edge, e.g., the 45° angle as shown or other angles. A pivotable guide member can also be provided to enable variations in the angles using a single guide.

In an alternative embodiment of the invention, the transfer tab 64 and the mating female press head, i.e., the matrix of holes 74, are replaced by a male cutting member which is mounted to the actuator 68 and the transfer tab 64 is replaced by a female member which has the same design as the male cutting member. As such, in this embodiment, the substrate is cut when the actuator 68 is pivoted over onto the substrate and pressed down. The actuator 68 may be squeezed closed under spring tension forcing the male cutting member through the substrate into the female member. The result is a punched out pattern in the shape of the male cutting member. The same guides 76, 88 may be used in this embodiment.

Referring now to FIG. 16, another technique for embossing a flat substrate such as paper involves use of an instrument 140 which includes a base member 142 and an actuator member 144 pivotally coupled to the base member 142. A press 146 is formed on or attached to the upper surface of the actuator member 144 to aid in exerting pressure via the actuator member 144 against the base member 142.

Instrument 140 includes a first pad 148 arranged on the base member 142 and a second pad 150 arranged on the actuator member 144 at least partially opposite the first pad 148. The first and second pads 148, 150 may have the same dimensions and be positioned directly opposite one another, or the second pad 150 be larger than the first pad 148, or vice versa. The first pad 148 is arranged between the pivot point 152 and the press 146 at the end of the actuator member 144 such that downward pressure exerted on the actuator member 144 by the artist or craftsmen via the press 148 causes downward movement of the second pad 150 against the first pad 148.

In an exemplifying, but not limiting, use, the artist or craftsman first moistens the substrate and selects a die to be used, i.e., a die having a shape sought to be imprinted on the substrate. Moistening the substrate aids in formation and retention of the impression to be subsequently formed since, for example, wet paper is more resilient and thus more likely than dry paper to undergo deformation and provide a deep relief effect. The substrate may be wet using a wet sponge or simply placed underneath a faucet or other fluid source. Water is the preferred moistening fluid, although others may be used. Also, for some substrates, such as a synthetic substrate, moistening may be unnecessary, and for example, heating may be beneficial.

A form or die to be imprinted into the substrate is selected. The moistened substrate is placed on the first pad 148, the die is placed over the substrate at the desired location at which formation of the imprint is desired, and then the artist or craftsman presses down on the actuator member 146 until the second pad 150 contacts the form or die. This pressure causes imprinting of the shape of the form or die into the substrate. The pressure is maintained for a period of time necessary to create the imprint, which time will be readily ascertained through use of the instrument 140. After the substrate is pressed, it may be dried to be able to better retain the imprint and also to enable easier handling.

When constructing the instrument 140, it is necessary to consider that the impressions to be formed using the instrument will be as deep as the softness of the first and second pads 148, 150. For example, if foam is used for the pads 148, 150, the impressions will be as deep as the softness of the foam, although the resiliency of the paper is also a factor. Neoprene foam may be one type of foam used in the invention.

Forms that may be used with the instrument 140 include various cookie cutters which are formed in different shapes and sizes and usually with a hollow interior. Moreover, it is possible to use ordinary objects for imprinting the substrate, such as scissors, watches, perfume bottles, pens, etc. There is no damage to these objects since they are sandwiched between two pads 148, 150 of, for example, resilient foam.

Variations of the instrument 140 and its use are also envisioned. For example, the form or die may be placed under the substrate with the same effect. A substrate may be placed both under and over the form or die. Multiple forms or dies may be used in a single pressing. The same substrate may be pressed multiple times, at the same, overlapping or different portions to create a substrate with multiple imprints.

Referring now to FIGS. 17-21, another instrument in accordance with the invention for modifying flat substrates is designated generally as 160 and is an index punch/embosser which allows for interior punching and/or embossing. Generally, instrument 160 is designed to index or advance the substrate exactly the distance of the width of an integrated punch. This allows the punch (a set of one or more cuts) or embossed pattern to repeat itself continually as desired by the artist. Thus, for example, if you have a punch pattern of a heart and it is 1″ in width, using instrument 160, it is possible to repeat the heart pattern as many times as desired to obtain a linear sequence of punched out or embossed hearts, with one being situated every inch along the substrate. Instrument 160 enables punching along an edge of the substrate, or punching or embossing in an interior of the substrate. This is accomplished by various stop guides which allow the substrate to travel and aid in positioning the substrate.

Instrument 160 includes a base 162 having a substantially planar upper surface on which the substrate is placed, an actuating member 164 which is pivotally coupled to the base 162, a punch 166 housed in the actuating member 164 and an actuating lever 168 pivotally coupled to the actuating member 164 and arranged to pivot into engagement with the punch 166. To this end, the lever 168 includes a projection 180 which is designed to concentrate and improve the exertion of force against the punch 166.

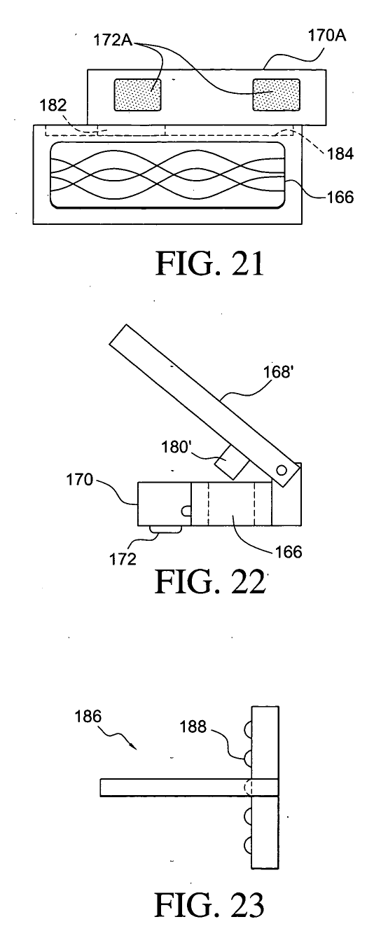

Further, instrument 160 includes a mechanism to index the substrate relative to the actuating member 164. The indexing mechanism includes a lever 170 movably attached to the actuating member 164 and positioned so that it can be manually moved the exact distance of the width of the pattern provided by punch 166. Lever 170 engages the upper surface of the substrate and when pressure is exerted thereon, it can advance the substrate the distance equal to the width of the punch 166. To this end, the lever 170 may be provided with one or more projections on its lower surface, e.g., a small metal or rubber-covered metal prong 172 as shown in FIG. 20, or sandpaper, an eraser or other friction-creating element or member. Also, FIG. 21 shows a lever 170A with two such projections 172A. The projection 172 may be pivotally arranged in the lever 170 to have an operative substrate-engaging position and a relaxed non-substrate-engaging position (where it pivots back into a well or opening 192 in the lower surface of the lever 170).

Lever 170 is also arranged to enable it to be moved back to its initial position after each indexing or advance, while out of engagement with the substrate. This may be achieved by providing a projection 182 in the lever 170 and a slot 184 on the actuating member 164, or vice versa, with the slot having the length of the permitted travel path of the lever 170 (see FIG. 21).

While it is preferable that the lever 170 is constructed to provide an advance corresponding to the distance of the punch 166 in order to achieve a continuous pattern, i.e., formation of multiple patterns by the punch 166 in sequence with each pattern immediately following the preceding pattern, it is possible to have the lever 170 advance more or less, thus creating added features. For example, if the lever 170 were designed to move 1.5 inches, the punch 166 (a one inch punch) would have a space of about 0.5 inches between punches. This provides additional flexibility for this invention. If it only advanced, for example, 0.5 inches, then there would no longer be a heart pattern, but a series of waves.

It is also possible to vary the orientation of the substrate so that for perpendicular or parallel patterns of the punch, the artist would take the substrate out after punching it once and rotate it, e.g., 90° or 180°. It is also possible to rotate the substrate at an acute angle, e.g., 45°, and create the punch pattern along different angles.

Instrument 160 therefore functions in a similar manner as prior art punches, which can be modified in accordance with the teachings of the invention. A substrate is slipped into the punch to the interior limit, defined by a positioning edge 176 of flaps 174 pivotally attached to the base 162 and the lever 168 is then pivoted against the punch 166 forcing the punch 166 clean through the substrate. Although two flaps 174 are shown, a single flap or other numbers of flaps may be provided.

Also, a significant improvement over prior art punches is that by raising the flaps 174, it is possible to place the substrate so that the punch 166 is able to punch into an interior region of the substrate. Thus, instrument 160 can emboss, imprint or cut into an edge region of the substrate as well as in an interior region of the substrate, the extent of which depends on the length of the actuating member 164 which extends over the edge of the substrate into the interior thereof. In this regard, a movable or adjustable rail may be provided that allows adjustability from edge punching to deeper interior punching. As shown in FIG. 23, the adjustable rail 186 has a T-shape and is designed to move along an edge of the base 162 and its position can be secured relative to the base at predetermined and fixed positions via the male/female engagement structure 188, 190.

Further, a guide member, such as a guide member 88 shown in FIG. 15, can be use din this embodiment, to enable punching on corners instead of on straight, linear edges.

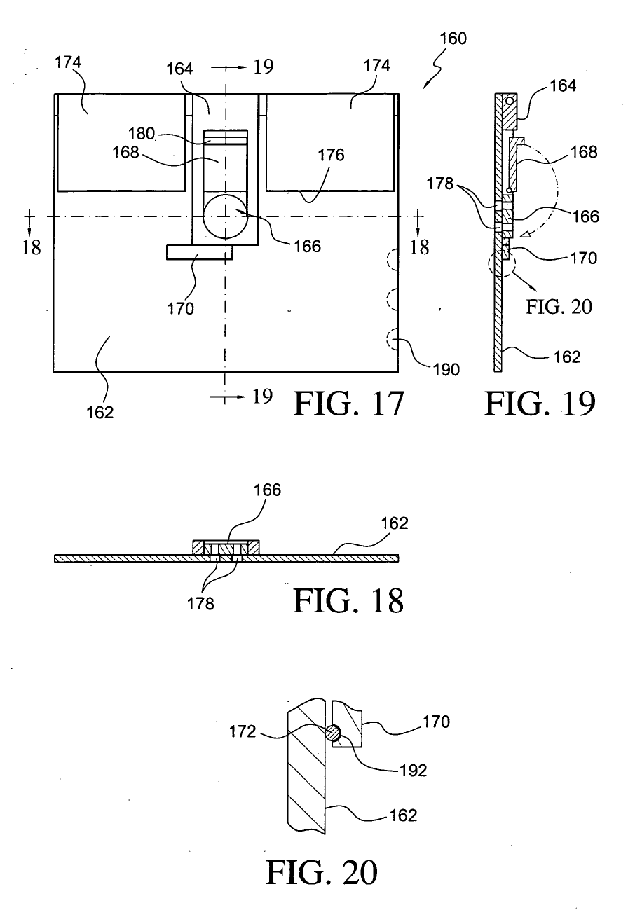

In one embodiment, the punch 166 is a male member with projections or cutting elements and the base 162 includes a complementary female member, e.g., a pattern of openings 178 aligning with the projections or cutting elements (see FIGS. 18 and 19). The base 162 can instead include a large opening encompassing the entire area below the punch 166. The base 162 can also be provided with a removable container underneath the opening to receive the cut portions of the substrate. The lever 170 is then grasped and advanced causing the substrate to be advanced as well, and then disengaged form the substrate and returned to its initial position. The result is a punched out pattern (heart, diamond, wavy line, etc.) in the substrate. The cut-out portions of the substrate fall through the openings 178 to an area below the base 162 and can be cleaned away when the base 162 is moved.

In general then, instrument 160 includes a punch which is capable of forming a pattern or punching out particular portions of a substrate, and a mechanism for moving the substrate a set amount relative to a punch, e.g., while the punch is maintained in a fixed position relative to the substrate.

In comparison to existing prior art punches, the instrument 160 is uniquely capable of precision punching (or embossing) in a smooth continuous indexing fashion which results in perfect registration along the edge or in the interior of the substrate. It must be understood that the existing punches and embossers may be modified to include the indexing mechanism in accordance with the invention. A modification of such existing punches would likely entail placement of the lever 170 to the punch mechanism and formation of a movement channel or slot on the punch to enable the indexing movement of the lever 170.

Accordingly, instrument 160 is a precision tool that is capable of producing a continuous repeat pattern on paper, metal foil, synthetic substrate and the like. It provides the hobbyist, scrapbook hobbyist, quilter and graphic artist with the ability to easily produce repeat patterns on paper, foil, fabric etc. along the edge, as well as in the interior of the sheet substrate. The instrument 160 also allows for easy changing of different patterns for subsequent repeating patterns. Moreover, in use, the substrate can be rotated so as to punch or emboss at different angles, such as that of a corner. Instrument 160 allows for accurate and precise indexing of the substrate, while the male/female die remains fixed and perfectly registered. As such, the instrument 160 provides a unique method for parallel die cutting or embossing, for example, instrument 160 can produce parallel designs of the same or different patterns by changing male and female cutting or embossing members.

FIG. 22 shows a variation of the actuating member 164 wherein a larger lever 168′ is provided and has a projection 180′ proximate the pivot point.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. An instrument for modifying flat substrates, comprising:
an operative unit for modifying the substrate; and
means for positioning the substrate relative to said unit to enable said unit to interact with the substrate and modify it.

2. The instrument of claim 1, further comprising a housing, said operative unit comprising at least two rollers defining at least one nip therebetween through which the substrate passes, at least a first one of said rollers including at least one modification component which depresses or cuts the substrate when the substrate is passed through the nip.

3. The instrument of claim 2, wherein at least one of said rollers is replaceable to enable multiple rollers with different patterns of modification components to be arranged in said housing.

4. The instrument of claim 2, further comprising a mechanism for rotating said rollers to cause the substrate to be drawn into the nip between said rollers.

5. The instrument of claim 2, wherein at least a second one of said rollers forming the nip with said first roller has a rubber covering.

6. The instrument of claim 2, further comprising a front lever pressure plate arranged to enable pressure to be manually exerted against one of said rollers in a direction toward another of said rollers forming a nip therewith.

7. The instrument of claim 2, wherein said housing includes a container portion defining a receptacle for modified substrates and an operative portion housing said rollers, said container portion including a slot through which the modified substrates pass and said operative portion including a slot into which unmodified substrate is passed into the nip defined by said rollers.

8. The instrument of claim 1, wherein said operative unit comprises a housing, a rotatable shaft extending from said housing, an electrical unit arranged at least partly in said housing for providing power to rotate said shaft and means for actuating said electrical unit to initiate rotation of said shaft, said shaft including a threading slot at a tip spaced from said housing, whereby upon insertion of a leading edge of a strip of the substrate in said slot and actuation of said electrical unit, said shaft rotates and twists the strip into a curved form.

9. An assembly including the instrument of claim 8 and a work board defining at least one geometric form having an inlet into an interior thereof, said tip being inserted into an interior of said at least one geometric form with the substrate extending through said inlet and then said shaft being rotated to thereby cause the substrate to achieve a shape corresponding to said at least one geometric form.

10. The instrument of claim 1, wherein said operative unit comprises a base, a transfer tab arranged in connection with said base and an actuator for pressing the substrate against said transfer tab, said actuator being pivotally coupled to said base and said base including a receptacle for removably receiving said transfer tab.

11. The instrument of claim 10, wherein said transfer tab includes a plurality of raised projections tapering to a point and said actuator includes a plurality of holes which align with said projections.

12. The instrument of claim 10, wherein said positioning means comprise a guide mechanism arranged in connection with said base for positioning the substrate relative to said transfer tab.

13. The instrument of claim 12, wherein said guide member includes a pair of edges defining an acute angle therebetween.

14. An instrument for modifying a flat substrate, comprising:
a base member;
an actuator member movably coupled to said base member;
a first pad arranged in said base member; and
a second pad arranged on said actuator member is a position in which said second pad contacts said first pad when said actuator member is moved toward said base member.

15. A method for using the instrument of claim 14, comprising:
placing a flat substrate and a form or die between said first and second pads; and
then moving said actuator member toward said base member to press the form or die and the substrate between said first and second pads.

16. An instrument for modifying flat substrates, comprising:
a base having a substantially planar upper surface on which the substrate is placed;
an actuating member movably coupled to said base;
a punch housed in said actuating member;
an actuating lever coupled to said actuating member and arranged to pivot into engagement with said punch; and
indexing means for selectively advancing or indexing the substrate relative to said actuating member and thus said punch.

17. The instrument of claim 16, wherein said indexing mechanism includes a lever movably attached to said actuating member and positioned so that it can be manually moved the exact distance of the width of a pattern provided by said punch, said lever being arranged to engages the substrate so that when pressure is exerted on said lever, said lever advances the substrate the distance equal to the width of said punch and in a return movement, said lever is removed from engagement with the substrate.

18. The instrument of claim 17, wherein said lever includes at least one projection extending downward from a lower surface to engage the substrate.

19. The instrument of claim 16, wherein said punch is removable from said actuating member.

20. The instrument of claim 16, wherein said punch includes means for cutting substrate and said base includes an opening below said cutting means through which the cut portions of the substrate fall.
